(19) United States
(12) Patent Application Publication
(10) Pub. No.: US 2001/0006028 A1
(43) Pub. Date: Jul. 5, 2001

(54) Printing plate and printer using it

(76) Inventors: Hiroshi Sasaki, Mlto (JP); Mitsuyoshi Shouji, Jyuo (JP); Sachiko Shouji, Jyuo (JP); Kenichi Kawashima, Hitachinaka (JP); Yutaka Ito, Takahagi (JP); Teruaki Mitsuya, Naka (JP); Nobuyoshi Hoshi, Hitachinaka (JP)

Correspondence Address: Antonelli, Terry, Stout & Kaus, LLP, Suite 1800, 1300 North Seventeenth Street, Arlington, VA, 22209, US

(21) Appl. No.: 09/748,864

(22) Filed: Dec. 28, 2000

(30) Foreign Application Priority Data
Dec. 28, 1999 (JP) 11-372684

(51) Int. Cl. B41C 1/10; B41N 3/00

(52) U.S. Cl. 101/465; 101/478; 101/450.1

(57) ABSTRACT

The object of the present invention is to provide a printing system ensuring easy formation of a plate and regeneration of said plate, and a press plate thereof.

The above object can be attained by the present invention providing a press plate used in a printing system to form an image using water base ink characterized in that,

(1) prior to formation of a latent image, the surface forming the latent image exhibits extra ink-repellency to the ink to be used;

(2) said press plate allows a water soluble material forming the latent image to be deposited thereon;

(3) the latent image can be formed by allowing said water soluble material deposited on said press plate surface; and

(4) said press plate can be regenerated as an plate which allows a new latent image to be formed by washing said press plate with water and drying it, upon completion of ensuing processes of development and transfer.

### BACKGROUND OF THE INVENTION

The present invention relates to a printer using water based ink and a printing plate used in said printer.

Official Gazette of Japanese Patent Laid-Open NO. 310101/1996 discloses that patterned water based ink layer is formed by feeding water based ink to the plate having ink repellent substance in the non-printing area, and the patterned water based ink layer is transferred to the object to be printed. Official Gazette of Japanese Patent Laid-Open NO. 228066/1995 discloses that non-water soluble zinc compound powder provided with hydrophilic treatment is used as as component of the image receiving layer for the direct plotting offset printing plate.

A gravure printing printer or offset printing printer provides high-speed volume printing of advertisement fliers and books having the identical images. However, such a machine has problems when handling the images for a low volume production with a wide variety of types; namely, much time and cost are required to form the plate, and the plate cannot be recovered. An innovative idea, including invention of a printing method and a printer allowing recovery of a plate has been required to achieve effective production of printed matters in hundreds to thousands of copies required.

The object of the present invention is to provide a printer which ensures easy formation of a plate and recovery of the plate, and a printing plate.

### SUMMARY OF THE INVENTION

The authors of the present invention have studied many types of printing methods and have come to the conclusion that the above object can be achieved if a once used plate can be recovered, and the plate forming process can be reduced. Thus, they have studied various methods of facilitating plate formation, and have found out that it is possible to manufacture a system which can achieve the above object by using water based ink and an super-ink-repellent plate, and by utilizing a water soluble material for formation of a latent image.

The following is a specific description of our invention: The term “super-ink-repellent surface”, appearing in this Specification means that the surface does not allow deposition of a drop of ink equal to or greater in size than the minimum dot in the printing process. The minimum dot of the present printer was 10 microns in the embodiments. In this Specification, this surface is defined as a surface which repels a drop of ink having a size greater than that, namely, 10 microns or more, when said surface is brought in contact with said ink. Furthermore, the term “water soluble material” used in this Specification is defined as a substance which is 100% infinitely diluted with water at normal temperature and does not deposit on the super-ink-repellent surface.

(1) A printing plate used in a printer to form an image using water based ink characterized in that,

prior to formation of a latent image, the surface forming the latent image exhibits super-ink-repellency to the used ink;

said printing plate allows a water soluble material forming the latent image to be deposited thereon;

the latent image can be formed by allowing said water soluble material deposited on said printing plate surface; and

said printing plate can be recovered as an plate which allows a new latent image to be formed by washing said printing plate with water and drying it, upon completion of ensuing processes of development and transfer.

(2) A printer comprising at least;

a plate,

a mechanism forming a latent image on said plate

a mechanism allowing ink to be deposited and developed on said plate where the latent image is formed and

a mechanism to transfer said developed image onto paper;

and said ink is water based ink;

said printer characterized in that

prior to formation of a latent image, the surface of the plate exhibits super-ink-repellency to the used ink;

said printing plate allows a water soluble material forming the latent image to be deposited thereon;

the latent image can be formed by allowing said water soluble material deposited on said printing plate surface on said plate surface; and

a mechanism is provided to permit said printing plate to be recovered as an plate which allows a new latent image to be formed upon completion of ensuing processes of development and transfer;

said mechanism contains at least a device to remove ink deposited on said plate and a device to dry said plate.

(3) A printer according to claim 2 characterized in that a mechanism to heat said plate or transfer mechanism is added inside said plate and transfer mechanism.

(4) A printer according to claim 2 characterized in that a mechanism to suck waste water generated in said washing step is added.

### BRIEF DESCRIPTION OF THE DRAWINGS

FIG. 1 is a schematic diagram representing how to form an image according to the present invention;

FIG. 2 is a schematic diagram representing the configuration of the printing system according to the present invention;

FIG. 3 is a schematic diagram representing a latent image forming head according to the present invention;

FIG. 4 is a schematic diagram representing the configuration of the printing system according to Embodiment 3; and

FIG. 5 is a schematic diagram representing the configuration of the printing system according to Embodiment 4.

### DETAILED DESCRIPTION OF THE INVENTION

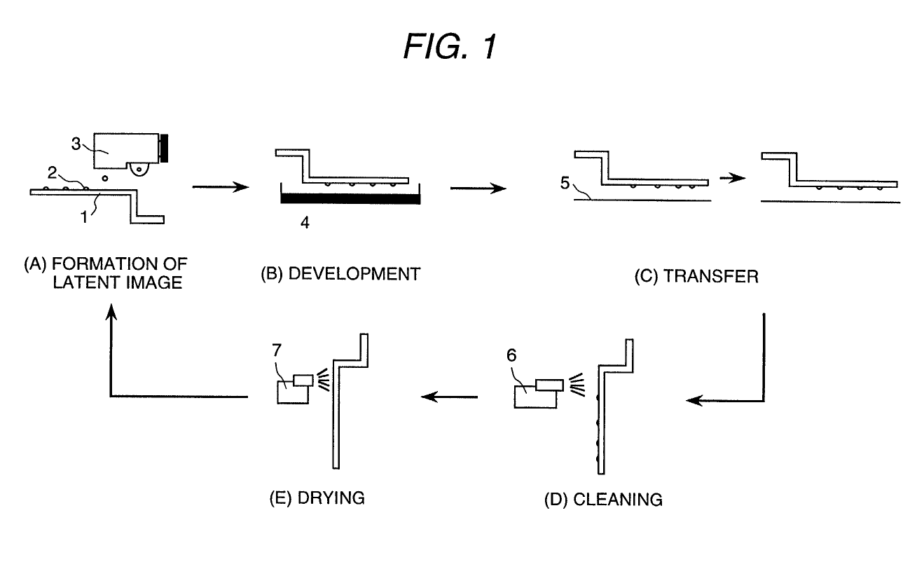

FIG. 1 shows the method of forming an image using a printing plate according to the present invention. The process flows in the following order: Formation of latent image on a plate 1, development and transfer. The surface of plate 1 where latent image is formed exhibits super-ink-repellency to ink to be used. Formation of latent image comprises a step of depositing water soluble material 2 onto the ink-coated portion of surface. The plate surface allows water soluble material 2 to be deposited thereon. This Figure shows that the water soluble material is ejected from the nozzle of head for latent image formation 3 by the ejecting method to be discussed later and is deposited on to the plate surface. It should be noted that the method of depositing the water soluble material is not restricted to this method alone. In development phase, plate 1 is dipped into pad 4 filled with ink. Then water based ink is deposited only onto the portion of the surface of plate 1 where water soluble material 2 is deposited. Transfer is a step of shifting onto paper 5 the image on the plate formed by ink. The process of printing is now complete. After printing, ink remains on the ink-deposited portion, and remains as a latent image since super-ink-repellency is lost. When multiple printed matters having the same image are to be printed, only the steps of development and transfer are repeated since the latent image is already formed on the plate 1 for the second copy and thereafter.

Furthermore, by providing a step of recovering the plate 1, it is possible to provide a plate which can be recovered, similarly to the organic photoconductor of a laser printer. Ink and a very small amount of water soluble material 2 used for formation of latent image are deposited on the plate 1 after completion of printing a required number of copies.

Furthermore, since super-ink-repellency is lost from ink deposited portion, recovery consists of two steps; removal of ink (including a very small mount of water soluble material) from the surface of the plate 1 and recovery of super-ink-repellency. They are a step of washing with water and a step of drying. Water washing step is to remove ink remaining on the surface of plate 1 and water soluble material 2. Ink and water soluble material 2 are water-soluble. So cleaner 6 blows water toward plate 1 to remove ink and water soluble material 2 from the surface of the plate 1. Drying is a step of removing water remaining on the surface of plate 1. This is carried out by hot air coming from a dryer 7. This recovers the super-ink-repellency on the surface of plate 1, making it possible to start a new image printing process.

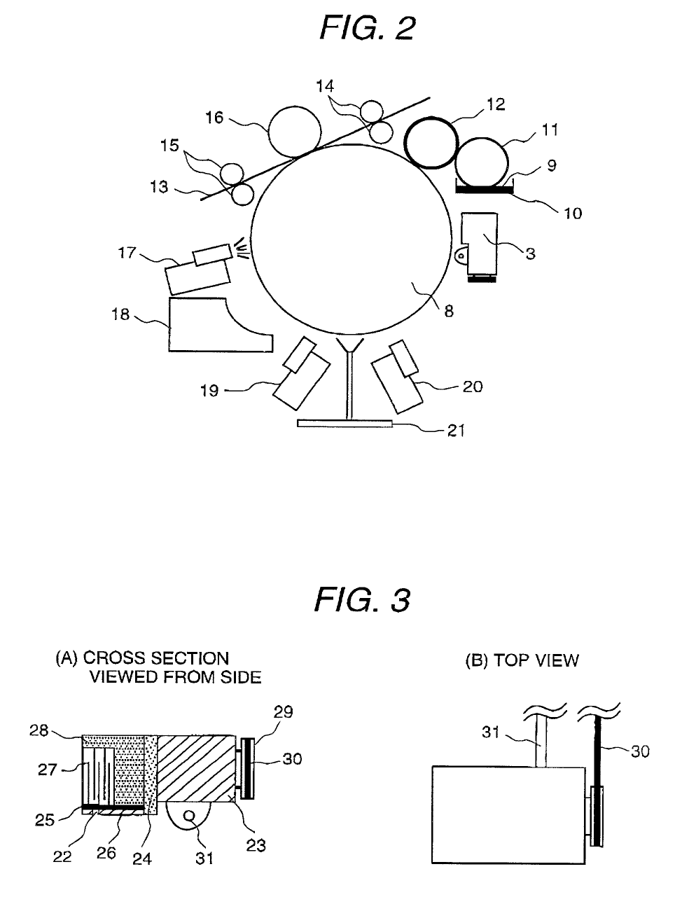

FIG. 2 is a schematic diagram representing the printer according to the present invention. The process of this printer also flows in the order of formation of a latent image on the plate, development and transfer. The surface of the plate 8 where latent image is formed exhibits super-ink-repellency. Formation of latent image consists of a step of depositing a water soluble material onto the portion of this surface where ink is to be applied. This Figure shows that the water soluble material is ejected from the nozzle of a head 3 for formation of latent image by the ejecting method to be discussed later and is deposited onto the surface of plate 8. Development consists of a step of applying water based ink only to the portion of the plate 8 where water soluble material is deposited. Ink 9 is applied to the plate 8 from a ink tank 10 via an ink transporting roll 11 and an ink transfer roll 12. Transfer is a step of shifting onto paper the image formed on the plate 8 by ink 9. Paper 13 is fed to a position between the plate 8 and transfer roll 16 by paper transporting rolls 14 and 15. After the step of transfer is carried out in this position, paper is fed by the paper transporting rolls 14 and 15. The printing process is now complete. When multiple printed matters having the same image are to be printed, only the steps of development and transfer are repeated since the latent image is already formed on the plate 8 for the second copy and thereafter.

A plate which can be recovered like the organic photoconductor of a laser printer can be provided by using a mechanism to recover the plate 8. Ink 9 is deposited on the plate 8 after completion of printing a required number of copies. Furthermore, super-ink-repellency is lost on the ink-deposited portion. Namely, recovery consists of two steps; removal of ink 9 and recovery of super-ink-repellency. They are a step of washing with water and a step of drying. Water washing step is to remove ink 9 remaining on the surface of plate 8. Ink 8 is water-soluble. Cleaner 17 blows water toward plate 8 to remove ink 9 from the surface of the plate 8. Waste water produced by washing is trapped by a waste water receiver 18. Drying is a step of removing water remaining on the surface of plate 8.

This is carried out by hot air coming from a dryer 19. This recovers the super-ink-repellency on the surface of plate 8, making it possible to start a new image printing process. Incidentally, frequent recovery of plate 8 may cause the plate 8 to become hot, so plate may be cooled by a cooling fan. Furthermore, a wind shield fence 21 can be installed to separate between hot air from the dryer 19 and cold air from the cooling fan 20.

The following describes the members, equipment and mechanism thereof used in each process.

### (1) OVERVIEW OF PLATE MATERIAL

FIG. 1 shows a board-shaped plate (a grip is attached for easy handling). FIG. 2 shows the drum-shaped one, but A belt-shaped one can be used. The plate is designed in such a structure that the super-ink-repellent surface is formed on the substrate of the base. When the super-ink-repellent surface is formed, the layer provided to improve close adhesion with the substrate is not subjected to any restriction. In the case of the board-shaped one, such a metal as aluminum, stainless steel and copper is hard to deflect, and is less susceptible to breakdown than glass, so it is suitable for use. For the drum-shaped one, the substrate made of aluminum is suitable in terms of resistance to corrosion and density. In addition, iron and copper can be considered, but they are not suitable since they are gradually corroded in air. Stainless steel poses no corrosion problem, but density is greater than that of aluminum. This problem is solved by using a thinner plate or a motor of greater torque. In the case of a belt, it is required that the substrate be hard to deflect due to a long-time operation of the printer. Unless there is plasticity, it does not fit with the belt driving roller. In this case, the roller diameter must be increased. When viewed from this viewpoint, polyethylene terephtalate (PET) and polytetrafluoroethylene (PTFE) can be mentioned as the material of the substrate. The thickness is set at 20 to 200 microns when the belt driving roller diameter is 5 cm. If greater thickness is to be used, the roller diameter can be increased.

A super-ink-repellent surface can be formed by applying to the substrate of a board, drum or belt a coating medium forming the super-ink-repellent surface (hereinafter referred to as “super-ink-repellent coating medium” for short). It can also be formed by coating the super-ink-repellent coating medium after the surface of the substrate is roughened. Furthermore, it can be formed by using the substrate made of fluorine-containing resin such as PTFE, tetrafluoroethylene - ethylene copolymer (ETFE) and tetrafluoroethylene - hexafluoropropylene copolymer (FEP), and by roughening the surface. Use of super-ink-repellent coating medium allows super-ink-repellent surface to be formed by a simple step of coating and heating. This is a great advantage. The following describe how to form an super-ink-repellent surface by super-ink-repellent coating medium.

### (1-2) Super-Ink-Repellent Coating Medium

The following describes the details of the super-ink-repellent coating medium and production method thereof: The super-ink-repellent coating medium comprises at least four materials; (1) ink repellent material to provide super-ink-repellency, (2) fine particles to give irregularities to super-ink-repellent surface, (3) resin to hold super-ink-repellent material and fine particles together, and (4) organic solvent to keep them dissolved and dispersed. These materials are not subjected to any restriction so long as the coated surface exhibits at least super-ink-repellency. The following describes each of these materials:

### (1-2-1) Resin

Resin can be epoxy resin, polyimide, glass resin, styrene/acryl resin, polyester or the like without any restriction. However, when printing resistance is taken into account, it is preferred to use the resin which is hardened or crosslinked by heat, for example, epoxy resin, melamine resin and glass resin.

### (1-2-2) Fine Particles

If fine particles are partially or wholly dissolved in the solvent used for super-ink-repellent coating medium, required irregularities on the super-ink-repellent surface may not be formed, so such fine particles are not preferred. Preferred fine particles are those which are hard to dissolve in solvent. Such materials are inorganic compound such as SiO₂, Al₂O₃ and TiO₂ (oxide is more stable). Furthermore, preferred fine particles also include the ferrite used as carrier in a copier and printer and the carbon black used as adsorbents. Fine particles should have an average particle diameter of 0.01 to 3 microns. If the diameter is smaller than 0.01 microns, irregularities are hardly formed on the surface. If it is greater than 3 microns, the physical strength of the super-ink-repellent coating medium tends to decrease. Especially in order to improve the super-ink-repellency, it is preferred to use particles having different average grain sizes. Authors of the present invention examined this point specifically and have found out that the super-ink-repellency on the surface is excellent if the ratio of average grain sizes between fine particles of greater size and those of smaller size is in the range from 50 to 1 through 0001.

### (1-2-3) Ink Repellent Material

Compound containing a long-chained alkyl group and fluorine compound containing fluorine atom inside the molecule can be used as ink repellent material. Of these, fluorine-containing compound is more preferred for efficiency in improving super-ink-repellency.

Perfluoroalkyl compound, perfluoropolyether compound and fluoro group substituted aromatic compound are available as fluorine-containing compound. Of these, perfluoroalkyl compound and perfluoropolyether compound are more effective to improve super-ink-repellency. When mixed with resin and others to prepare super-ink-repellent coating medium, the material is preferred to be dissolved into or mixed with the solvent used. Because this will ensure uniform distribution when coated film is formed. However, perfluoroalkyl compound or perfluoropolyether compound which has greater molecular weight has a low solubility into the organic solvent characterized by excellent miscibility with resin (acetone, ethylmethyl ketone, dichloro metal, N, N-dimethylformamide, N-methylpyrrolidone, isophorone, etc.). So solubility into these organic solvents is preferred to be ensured by bonding the appropriate residue to the end group. Solubility into organic solvent can be improved by the following means: Hydroxyl group such as linear or branched hexanol, octanol, cis- or trans-cyclohexanol and catechol derivatives is made to react with the material converted into alcoholate such as ON and OK, thereby bonding through ether bond the alkyl halide material where the end group of perfluoroalkyl chain or perfluoropolyether chain is alkyl halide material such as CH₂I or CH₂Br (where CH₂Br material has lower reactivity that CH₂I material). Furthermore, it is also possible to improve the solubility into organic solvent as follows: The material having amino group as the end group (for example, aniline, linear or branched hexylamine, octylamine and desylamine) is made to react with said alkyl halide, thereby achieving bonding it through amine bond. The material with perfluoroalkyl chain end group made of alkyl halide includes 2-(perfluoroalbutyl)ethyliodide, 2-(perfluorohexyl)ethyliodide, 2-(perfluorooctyl)ethyliodide, 2-(perfluorodesyl)ethyliodide, 2-(perfluoro-5-methylhexile)ethyliodide, 2-(perfluoro-5-methyloctyl)ethyliodide, 2-(perfluoro-5-methyldesyl)ethyliodide, 2, 2, 3, 3-tetrafluoropropyliodide-1H-1H, 7H-decafluoroheptyldiodide, etc.

Solubility into organic solvent can also be maintained by the following step: The material having CH₂OH as the end group of perfluoroalkyl chain or perfluoropolyether chain is made to react with the material with the end group consisting of alkyl halide (for example, benzylbromide, linear or branched hexylbromide, octylbromide and desylbromide), thereby achieving bonding through ether bond. Furthermore, solubility into organic solvent can also be maintained by the following method: The material having carboxyl group as the end group (benzoate, linear or branched chain, hexyl acid, octyl acid, decyl acid, etc.) is made to react with the material having CH₂OH at the perfluoroalkyl chain or perfluoropolyether chain end group, thereby achieving bonding through ester bond. The material with perfluoroalkyl chain or perfluoropolyether chain end group made of CH₂OH includes 2-(perfluorohexyl)ethanol, 2-(perfluorooctyl)ethanol, 2-(perfluorodesyl)desyl)ethanol, 3-(perfluorohexyl)propanol, 3-(perfluorooctyl)propanol, 3-(perfluorodesyl)propanol, Demnum SA by Daikin Kogyo, and Fonbrin Z-DOL by Augimont. The material based on Krytox 157FS by Dupont has its end group made of perfluoropolyether of carboxyl group. This end group can be reduced by lithium aluminum hydride to be converted into CH₂OH. Thus, this reduced material can also be used as a material with the end group made of CH₂OH.

Solubility into organic solvent can also be improved by the following step: The material with perfluoroalkyl chain or perfluoropolyether chain end group composed of CO₂H is made to react with the material having amino group as the end group (for example, aniline, linear or branched chain hexylamine, octylamine and desylamine), thereby achieving bonding through amido bond. Solubility into organic solvent can also be improved by the following step: The material having hydroxyl group as the end group (for example, linear or branched chain hexanol, octanol, cis- or trans-cyclohexanol and catechol derivative) is made to react with the material having CO₂H as the end group of perfluoroalkyl chain or perfluoropolyether chain, thereby achieving bonding through amido bond. The material having CO₂H as the end group of perfluoroalkyl chain or perfluoropolyether chain includes perfluorohexanoic acid, perfluorooctonic acid, perfluoro decanoic acid, 7H-duodecafluoroheptanoic acid, 9H-hexadecafluorononanoic acid, perfluoroazelaic acid, Demnum SA by Daikin Kogyo, Fonbrin Z-DIAC by Augimont and Krytox 157FS-L, 57FS-M and 157FS-H by Dupont.

Solubility into organic solvent can also be maintained by the following step: The material having epoxy group as the end group of perfluoroalkyl chain or perfluoropolyether chain is made to react with the material having amino group as the end group and the material having hydroxyl group as the end group, thereby achieving bonding through various forms of bond. The material having epoxy group as the end group of perfluoroalkyl chain or perfluoropolyether chain includes 3-perfluorohexyl-1, 2-epoxypropane, 3-perfluorooctyl-1, 2-epoxypropane, 3-perfluorodesyl-1, 2-epoxypropane, 3-(perfluoro-5-methylhexyl)-1, 2-epoxypropane, 3-(perfluoro-5-methyloctyl)-1, 2-epoxypropane, 3-(perfluoro-5-methyldesyl)-1, 2-epoxypropane, 3-(1H-1H, 7H-decafluoroheptyloxy)-1, 2-epoxypropane, 3-(1H-1H, 9H-hexadecafluorononyloxy)-1, and 2-epoxypropane.

Of the above fluorine-containing compounds, the following ones can be given as the compounds which are characterized by higher solubility into organic solvent and excellent miscibility with the monomer of epoxy resin as one of the resins used in forming the super-ink-repellent surface, where said compounds promotes formation of super-ink-repellent surface.

### Chemical Formula 1

Rf-(R)_{z} where Rf has the following structure:

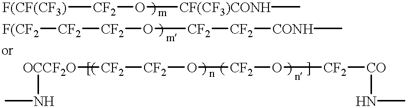

where m, m′ and n′ are natural numbers R- has the following structure:

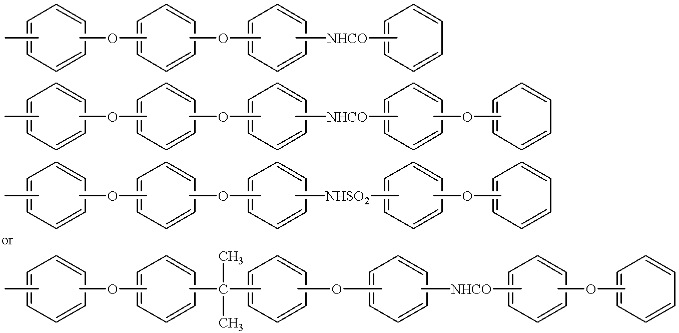

where z is 1 or 2.

Of these compounds, the following ones 1 to 11 are especially preferred because of excellent miscibility with glass resins in addition to epoxy resins.

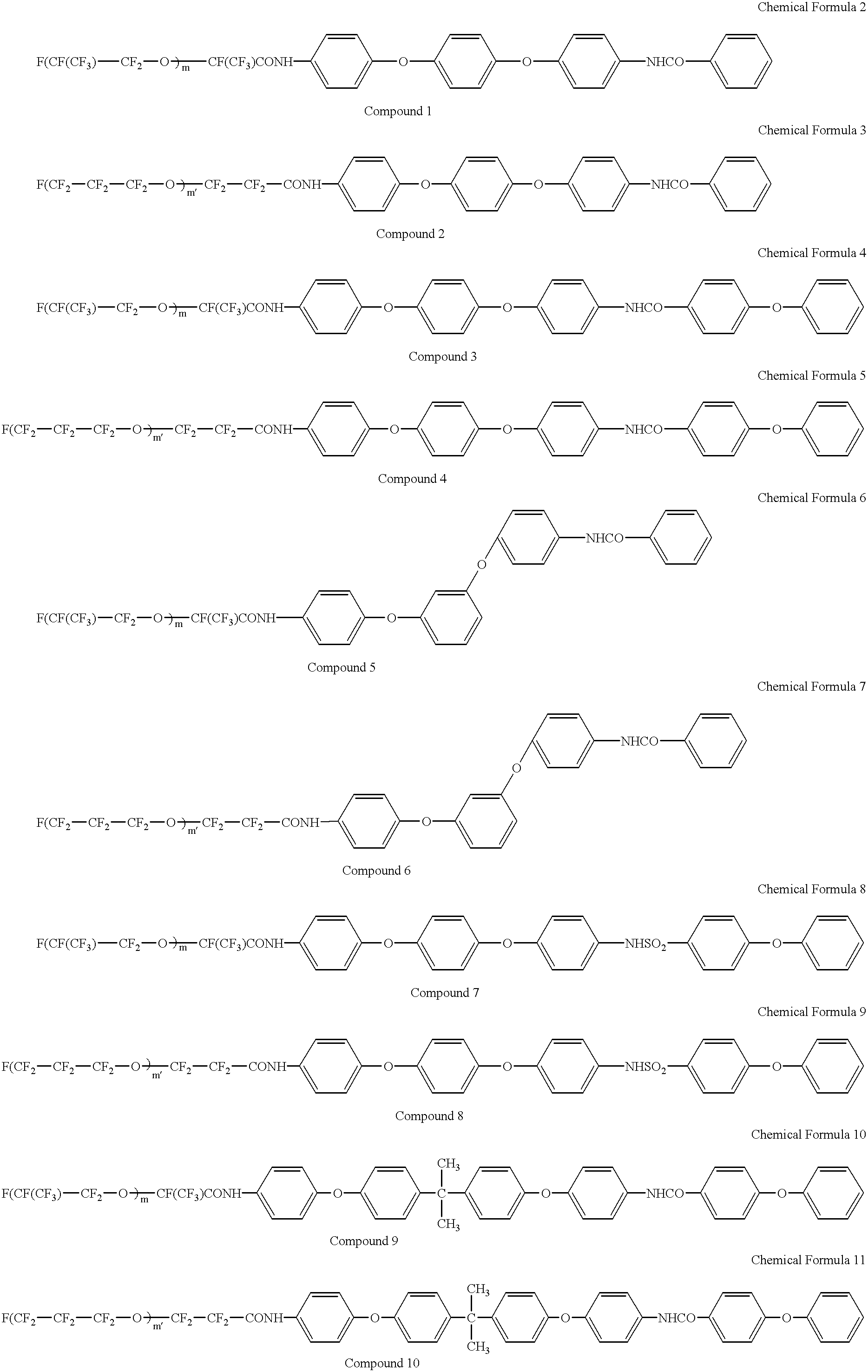

When the average molecular weight of the perfluoropolyether chain is 1500 to 5000 for compounds 1 to 8, 2000 to 9000 for compounds 9 and 10 and 2000 to 5000 for compound 11, miscibility with monomer is excellent, and suitability for use is ensured.

Perfluoropolyether chains having a recurring unit of —CF(CF₃)—CF₂O— use Krytox 157FS-L, 157FS-M or 157FS-H by Dupont as materials. Those having a recurring unit of —CF₂CF₂CF₂O— use Demnum SH by Daikin Kogyo as materials. Those with a recurring unit of —CF₂CF₂O— and —(CF₂O)— use Fonbrin Z-DIAC by Augimont as materials.

The following describes how to synthesize fluorine-containing compound.

### Synthesis of Compound 1

Krytox 157FS-L by Dupont (average molecular weight: 2500) (25 parts by weight) is dissolved into FC-72 (100 parts by weight) by 3M Co., Ltd., and thionyl chloride (2 parts by weight) and dichlormethane (20 parts by weight) are added to it. The solution was refluxed with agitation for 48 hours. Thionyl chloride and FC-72 are volatilized in an evaporator, thereby obtaining carbonal chloride derivative (25 parts by weight) of Krytox 157FS-L.

1,4-bis(4-aminophenoxy)benzene (29 parts by weight) and triethyl amine (25 parts by weight) made by Mitsui Toatsu Chemicals Co., Ltd. is dissolved into dichlor methane (300 parts by weight). While the solution is agitated, benzoyl chloride (14 parts by weight) dissolved into dichlor methane (100 parts by weight) is dripped to the solution for two hours. After that, it is agitated for another 20 hours. Reaction solution is filtrated by filter paper, and filtrate is concentrated by the evaporator. Then the solution is separated and refined by column chromatography (Wakogel C-200 made by Wako Junyaku Co., Ltd.), thereby obtaining compound 12 (20 parts by weight) having benzene ring on one side of the amino group.

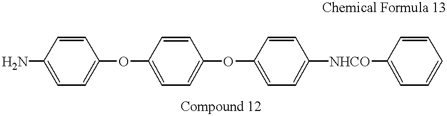

Add carbonal chloride derivative (25 parts by weight) of Krytox 157FS-L, compound 12 (4 parts by weight), triethyl amine (2 parts by weight) and dichlor methane (20 parts by weight) to FC-72 (100 parts by weight). Reflux it with agitation for 48 hours. Reaction solution is filtrated by filter paper, and filtrate is left to stand for 12 hours. The dichlor methane layer is removed from the surface, and new dichlor methane (20 parts by weight) is added. After agitation for one hour, it is left to stand for 12 hours. The dichlor methane layer is removed from the surface, and FC-72 in the lower FC-72 layer is volatilized by an evaporator and vacuum pump, thereby getting the intended compound 1 (25 parts by weight).

### Synthesis of Compound 2

Compound 2 (35 parts by weight) is obtained in the way similar to the method of synthesizing compound 1 except that Demnum SH by Daikin Kogyo (average molecular weight: 3500) (35 parts by weight) is used instead of Krytox 157FS-L of Dupont (average molecular weight: 2500) (25 parts by weight).

### Synthesis of Compound 3

Compound 13 (25 parts by weight) is obtained in the way similar to the method of synthesizing compound 12, except that 4-phenoxybenzoyl chloride (23 parts by weight) is used instead of benzoyl chloride (14 parts by weight).

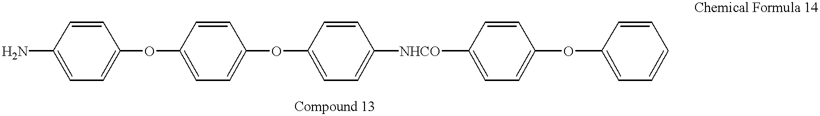

After that, compound 3 (25 parts by weight) is obtained in the way similar to the method of synthesizing compound 1 except that compound 13 (5 parts by weight) is used instead of compound 12 (4 parts by weight).

### Synthesis of Compound 4

Compound 4 (35 parts by weight) is obtained in the way similar to the method of synthesizing compound 3 except that Demnum SH by Daikin Kogyo (average molecular weight: 3500) (35 parts by weight) is used instead of Krytox 157FS-L of Dupont (average molecular weight: 2500) (25 parts by weight).

### Synthesis of Compound 5

Compound 14 (20 parts by weight) is obtained in the way similar to the method of synthesizing compound 12 except that 1,3-bis(4-aminophenoxy)benzene (29 parts by weight) made by Mitsui Toatsu Chemicals Co., Ltd. is used instead of 1, 4-bis(4-aminophenoxy) benzene (29 parts by weight).

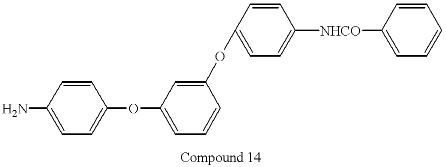

Compound 5 (25 parts by weight) is obtained in the way similar to the method of synthesizing compound 1, except that compound 14 (4 parts by weight) is used instead of compound 12 (4 parts by weight).

### Synthesis of Compound 6

Compound 6 (35 parts by weight) is obtained in the way similar to the method of synthesizing compound 5, except that Demnum SH by Daikin Kogyo (average molecular weight 3500) (35 parts by weight) is used instead of Krytox 157FS-L of Dupont (average molecular weight 2500) (25 parts by weight).

### Synthesis of Compound 7

Compound 15 (21 parts by weight) is obtained in the way similar to the method of synthesizing compound 12, except that 4-phenoxybenzene sulfonyl chloride (18 parts by weight) is used instead benzoyl chloride (14 parts by weight).

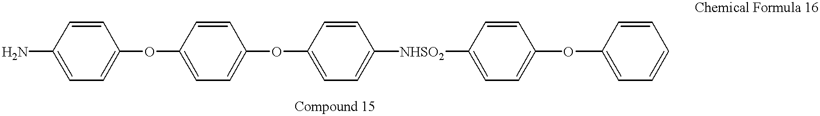

Compound 7 (25 parts by weight) is obtained in the way similar to the method of synthesizing compound 1 except that compound 15 (5 parts by weight) is used instead of compound 12 (4 parts by weight).

### Synthesis of Compound 8

Compound 8 (35 parts by weight) is obtained in the way similar to the method of synthesizing compound 7 except that Demnum SH by Daikin Kogyo (average molecular weight: 3500) (35 parts by weight) is used instead of Krytox 157FS-L of Dupont (average molecular weight: 2500) (25 parts by weight).

### Synthesis of Compound 9

Compound 16 (30 parts by weight) is obtained in the way similar to the method of synthesizing compound 12 except that 2,2-bis[(4-aminophenoxy)phenyl]propane (41 parts by weight) made by Mitsui Toatsu Chemicals Co., Ltd. is used instead of 1, 4-bis(4-aminophenoxy) benzene (29 parts by weight).

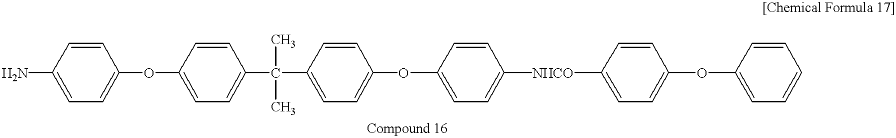

Compound 9 (25 parts by weight) is obtained in the way similar to the method of synthesizing compound 1, except that compound 16 (7 parts by weight) is used instead of compound 12 (4 parts by weight).

### Synthesis of Compound 10

Compound 10 (35 parts by weight) is obtained in the way similar to the method of synthesizing compound 9, except that Demnum SH by Daikin Kogyo (average molecular weight 3500) (35 parts by weight) is used instead of Krytox 157FS-L of Dupont (average molecular weight 2500) (25 parts by weight).

### Synthesis of Compound 11

Fonbrin Z-DOL by Augimont (average molecular weight 4000) (40 parts by weight) is dissolved in FC-72 (200 parts by weight). N, N-dicyclohexyl carbodiimide (5 parts by weight), compound 16 (13 parts by weight), and dicyclomethane (100 parts by weight) are added to it and are agitated for 120 hours. After the reaction solution is filtrated by filter paper, filtrate is left to stand for 12 hours. The dichlor methane layer is removed from the surface, and FC-72 in the lower FC-72 layer is volatilized by an evaporator and vacuum pump, thereby getting the intended compound 11 (40 parts by weight).

### (1-2-4) Super-Ink-Repellent Coating Medium Production Method

The super-ink-repellent coating medium is prepared by sufficient mixing of four materials; organic solvent, said ink repellent material, fine particles and resin. Mixing can be made by any of the following appropriate equipment without being restricted to any particulate means; an agitating tool, agitating rod, agitating machine and ultrasonic cleaner. When an agitating machine is used, a great deal of air may be taken in during the coating step. If the substrate of the plate is coated under this condition, air bubbles remain on the coating film surface. It is dried in this state, irregularities of about 0 to 1 mm will be formed on the surface, and this will reduce resolution in image formation. In this case, vibration can be given to coating medium by an ultrasonic cleaner or the like, thereby removing gas therefrom.

### (13) By Coating the Ink Repellent Material After Roughening the Substrate Surface

The following describes the method of forming the super-ink-repellent surface by coating the ink repellent material after roughening the substrate surface: Roughening can be achieved by polishing the surface with sand paper or by sand blast method. It can also be achieved by applying the coating medium containing fine particles of appropriate size distributed therein. In this case, if fine particles used are poorly distributed, improvement must be made by using the surfactant. To put it more specifically, non-ionic surfactant tends to exhibit greater miscibility with organic solvent than ionic surfactant.

Ink repellent material to be coated after roughening includes the compound containing long-chained alkyl and fluorine compound containing fluorine atom in the molecule. Of these, fluorine-containing compound is more preferred for improving ink repellency. Furthermore, use of the material making a chemical bond with the surface in addition to providing mere coating is still more preferred because it improves durability as well. The compounds having the following structures can be mentioned:

Rf—(CH₂)₃—Si(OR′)₃

where Rf has the following structure:

F(CF(CF₃)—CF₂—O)ₘ—CF(CF₃)CONH—

or

F(CF₂—CF₂—CF₂—O—)_{m′}—CF₂—CF₂—CONH—

where m and m′ are natural numbers

R′ is CH₃ or C₂H₅

Rf′—(CH₂)ₚ—Si(OR′)₃

Rf′- has the following structure:

F(CF₂)_{q}—

Rf″—Si(OR′)₃

Rf″- has the following structure:

H(CF₂)ᵣ—

where p, q and r are natural numbers

To put it specifically, the following compounds 17 to 25 can be mentioned:

Chemical Formula 19

F(CF(CF₃)—CF₂—O)ₘ—CF(CF₃)CONH—CH₂CH₂CH₂—Si(OC₂H₅)₃

### Compound 17

Chemical Formula 20

F(CF₂CF₂CF₂—O—)_{m′}—CF₂CF₂CONH—CH₂CH₂CH₂—Si(OC₂H₅)₃

### Compound 18

Chemical Formula 21

F(CF(CF₃)—CF₂—O—)ₘ—CF(CF₃)CONH—CH₂CH₂CH₂—Si(OCH₃)₃

### Compound 19

Chemical Formula 22

F(CF₂)₆—CH₂CH₂—Si(OC₂H₅)₃

### Compound 20

Chemical Formula 23

F(CF₂)₈—CH₂CH₂—Si(OC₂H₅)₃

### Compound 21

Chemical Formula 24

F(CF₂)₈—CH₂CH₂—Si(OCH₃)₃

### Compound 22

Chemical Formula 25

H(CF₂)₆—Si(OC₂H₅)₃

### Compound 23

Chemical Formula 26

H(CF₂)₁₀—Si(OC₂H₅)₃

### Compound 24

Chemical Formula 27

H(CF₂)₁₀—Si(OCH₃)₃

### Compound 25

having perfluoroalkyl chain, the compound having perfluoropolyether chain and the compound having fluoro group or trifluoro methyl group on the aromatic ring are cited as fluorine-containing compounds. Of these, the compound having perfluoroalkyl chain and compound having perfluoropolyether chain are more effective in improving ink repellency. Furthermore, the compound containing hydrogen as the end group of one side of the perfluoroalkylene chain is also effective.

If the number of q's in the perfluoroalkyl chain is too small, water repellency is reduced. To put it more specifically, it is preferred to be 3 or more. Water repellency is also reduced if the number of r's in the compound containing hydrogen as the end group of one side of the perfluoroalkylene chain. Specifically, it is preferred to be 6 or more. Furthermore, water repellency is also reduced if the molecular weight of the compound having perfluoropolyester chain is too small. The molecular weight is preferred to be 800 or more. The end group of perfluoroalkyl chain or perfluoropolyether chain has such trialkoxysilyl group as trimethoxysilyl group or triethoxysilyl group which is a residue to form chemical bond with the roughened surface. These residues are made to react with hydroxyl group on the surface by heating, and are fixed on the surface through oxygen atom. When these compounds are placed in a hot and humid place, trialkoxysilyl group as the end group is vulnerable to hydrolyzation. So these components are preferred to be stored in a refrigerator. The compound with trimethoxysilyl group as the end group is more vulnerable to hydrolyzation than the compound with triethoxysilyl group. When stability in preservation is taken into account, the compound having the triethoxysilyl group as the end group is more preferred.

Any of spin coat and dip coat methods can be used for coating on the roughened surface of these compounds. Solvent used is preferred to allow the compound to be dissolved therein. Some compounds dissolve in alcohol based solvent, but they react with water in solution to cause polymerization. This may result in shorter service life as coating solution. In this respect, fluorine based solvent is preferred because water does not easily dissolve in it. In addition, the surface tension of fluorineb-based solvent is small, so coating solution spreads very thinly over the surface. This means an advantage that a thin film can be produced. The fluorine based solvent includes FC-72, FC-77, PF-5080, HFE-7100 and HFE-7200 by 3M Co., Ltd., and Vertrel XF by Dupont.

Of the fluorine-containing compound shown in the present Specification, compounds 20 to 25 are released as commercial products from such chemical companies as PCR Incorporated and Daikin Kogyo. The following describes the method of synthesizing the compounds 17 to 19 as remaining fluorine-containing compounds:

### Synthesis of Compound 17

Krytox 157FS-L by Dupont (average molecular weight: 2500) (25 parts by weight) is dissolved into PF-5080 (100 parts by weight) by 3M Co., Ltd., and thionyl chloride (20 parts by weight) is added to it. The solution was refluxed with agitation for 48 hours. Thionyl chloride and PF-5080 are volatilized in an evaporator, thereby obtaining carbonal chloride derivative (25 parts by weight) of Krytox 157FS-L. PF-5080 (100 parts by weight), Saira Ace S330 (3 parts by weight) by Chisso Co. and triethylamine (3 parts by weight) are added to it. The solution is agitated for 20 hours at the room temperature. Reaction solution is filtrated by Radiolite Fineflow A by Showa Chemical Industry Co. Ltd., and PF-5080 in the filtrate is volatilized to get compound 17 (20 parts by weight).

### Synthesis of Compound 18

Compound 18 (30 parts by weight) is obtained in the way similar to the method of synthesizing compound 17 except that Demnum SH by Daikin Kogyo (average molecular weight: 3500) (35 parts by weight) is used instead of Krytox 157FS-L of Dupont (average molecular weight: 2500) (25 parts by weight).

### Synthesis of Compound 19

Compound 19 (20 parts by weight) is obtained in the way similar to the method of synthesizing compound 17 except that Saira Ace S320 (3 parts by weight) by Chisso Co. is used instead of Saira Ace S330 (3 parts by weight) by Chisso Co.

### (2) LATENT IMAGE FORMATION SYSTEM

### (2-1) Overview

This system is designed to deposit the water soluble material onto the plate, thereby improving hydrophilic characteristic is improved on the deposited portion. As a result, water based ink is deposited there and to form an image. The step of causing the water soluble material to be deposited is to form a latent image on the plate surface. Consequently, the water soluble material must be in the form of liquid when it is deposited on the plate. Even if it is solid, it can be attached to the plate surface by making it into aqueous solution. Or even if it is solid, it can be attached to the plate surface by heating and melting. The system of allowing the water soluble material to be attached to the plate includes a method of discharging it from a small-diameter nozzle when resolution is taken into account (hereinafter referred to as “ejecting method”). This method is preferred in the sense that resolution can be controlled according to the size and profile of the liquid drops to be ejected. The details of this method will be described later. Furthermore, an image can also be formed by applying the water soluble material on the plate using a felt, brush, cotton, etc. In the case of this method, resolution is determined by the size of the brush to be used. So improvement of resolution is more difficult than in the case of said ejecting method.

### (2-2) Ejecting Method

FIG. 3 is a schematic diagram of the device (head for latent image formation) used in the ejecting method. The water soluble material is subjected to pressure due to the piezo unit, and is ejected from a small-diameter nozzle. The pieze unit applies pressure directly to the water soluble material through electric signals. This makes it possible to get a high sensitivity to eject and to ensure easy regulation of ejection volume. The following describes the specific operations:

From the nozzle 22 of the head for latent image formation, water soluble material is ejected toward the portion where the ink of the plate is to be coated. The head for latent image formation has a water soluble material tank 23. A sponge 24 is fixed on one of the sides of this tank 23. The water soluble material little by little penetrates into the nozzle 22 through this sponge 24, and is spread in the form of thin film between a certain side of the nozzle and diaphragm 25 (a thin film 26 of water soluble material in FIG. 3). In this case, however, the size of the nozzle 22 is determined to ensure that the substance is ejected only when pressure is applied from the diaphragm 25, with consideration given to the surface tension of the water soluble material. To put it more specifically, it is preferred not to exceed 100 microns. Ejection from the nozzle 22 allows the diaphragm 25 to be deformed in a convex shape toward the side of the nozzle 22 by the piezo unit 27. The diaphragm 25 pushes the thin film 26 of the water soluble material toward the nozzle 22. This is followed by the water soluble material being ejected from the nozzle 22. The operation of the piezo unit 27 is controlled by the piezo unit control system 28. The head for latent image formation is equipped with a pulley 29, and is driven by the belt 30 attached to the pulley 30. Assuming that the direction where the plate rotates is the y-axis direction; then the direction where the head is driven by the belt 30 is the x-axis direction. To give stability to the movement in the X-axis direction, the head is equipped with a guide rail 31.

When the head for latent image formation is configured, the position where the piezo unit 27 applies pressure to the diaphragm 25 is preferred to be located in the vicinity of the ejection port of the nozzle 22, thereby improving regulation to ink eject. The volume and shape of the water soluble material to be ejected varies according to the inner diameter and shape of the nozzle 22 and the distance between the plate and nozzle 22. This requires the device to be manufactured while the piezo unit 27 and these factors are adjusted. From the result of our experience, we have learnt that resolution can be improved by a smaller ejection volume. To put it more specifically, the ejection volume of water soluble material to form one dot is required to be about 1×10⁻⁹ cm³ in order to get a resolution of 2400 dpi.

During discharging step, the water soluble material may be deposited on the nozzle 22 and the surrounding area. This problem can be solved to some extent by improving the liquid separation of the nozzle 22. One of the solutions of this problem is to provide water repellent surface treatment of the nozzle 22 and its vicinity. To put it more specifically, the nozzle and its vicinity are coated with the fluorine-containing compound such as compounds 17 to 25 according to the present invention, and is heated thereafter.

### (2-3) Water Soluble Material

The water soluble material is first required to be deposited on the plate surface. To meet this requirement, the substance is preferred to have a smaller surface tension. To put it more specifically, the surface tension is preferred to be 50 mN/m or less. The substance is not allowed to swell or melt the plate surface. Furthermore, for the surface of the plate manufactured by use of an super-ink-repellent coating medium, the substance cannot be used if it allows the ink repellent material to be dissolved therein. Of the ink repellent materials, for example, said compounds 1 to 11 cannot be used since they are dissolved into the ketone based solvent (acetone methylethyl ketone, cyclohexanone, etc.).

In addition, when a highly volatile substance is used, there is a problem that latent image disappears before ink adheres. Such substances include methanol, ethanol, propanol, isopropanol, isobutanol and t-butanol. Furthermore, organic substances containing amino group such as as ethylamine, diethylamine, triethylamine and tributylamine are offensive smelling, and are not practical.

According to our examination, the preferred substances are glycol based compounds such as ethyleneglycol, diethyleneglycol, triethyleneglycol, tetraethyleneglycol, propylene glycol, ethyleneglycol monomethylether, ethyleneglycol monoethylether, ethyleneglycol monopropylether, diethyleneglycol monomethylether and diethyleneglycol monoethylether. They are less volatile, and less offensive smelling.

Further to the above, aqueous solutions of hydrophilic high polymers such as polyvinyl alcohol, polyethylene imine, polyacrylic acid and polyallylamine can also be used. However, if these polymers have a excessively high concentration, viscosity is also high; therefore, a high resistance will occur when ejected from the nozzle. They are hard to eject. Furthermore, if concentration is too low, the substance is not easily deposited on the plate. Concentration varies according to the type of the resin and average molecular weight. In the case of polyvinyl alcohol, ejection performances and deposition characteristics are excellent at 3 to 10 wt %. Furthermore, the substance having a greater average molecular weight has a higher viscosity when the concentration is the same; therefore, lower concentration is preferred. It should be noted that hydrophilic polymer is a solvent, but viscosity will be increased when water evaporates. This makes it hard to eject. Consequently, organic liquid such as ethyleneglycol which can be used in bulk is more preferred to the aqueous solution of hydrophilic polymer. Table 1 summarizes the excerpt of the characteristics of the water soluble materials we have evaluated.

TABLE 1
Characteristics of water soluble materials used for
latent image formation

| | | Ejection | Latent | |
|---|---|---|---|---|
| | | charac- | image | |
| Classifi- | | teristics | reten- | Odor |
| cation | Evaluated water soluble materials | (1) | tion (2) | (3) |
| Glycols | Ethyleneglycol | ◯ | ◯ | ◯ |
| | Diethyleneglycol | ◯ | ◯ | ◯ |
| | Triethyleneglycol | ◯ | ◯ | ◯ |
| | Tetraethyleneglycol | ◯ | ◯ | ◯ |
| | Pentaethyleneglycol | ◯ | ◯ | ◯ |
| | Hexaethyleneglycol | ◯ | ◯ | ◯ |
| | Ethyleneglycol monoethylether | ◯ | ◯ | ◯ |
| | Diethyleneglycol monomethylether | ◯ | ◯ | ◯ |
| | Tetraethyleneglycol | ◯ | ◯ | ◯ |
| | monomethylether | | | |
| | Ethyleneglycol mono-n-ethylether | ◯ | ◯ | ◯ |
| | Tetraethyleneglycol mono-n- | ◯ | ◯ | ◯ |
| | ethylether | | | |
| | Polyethyleneglycol 200 10 wt % | ◯ | ◯ | ◯ |
| | solution | | | |
| | Polyethyleneglycol 2000 5 wt % | ◯ | ◯ | ◯ |
| | solution | | | |
| | Polyethyleneglycol 200000 3 wt % | ◯ | ◯ | ◯ |
| | solution | | | |
| Alcohols | Methanol | ◯ | x | ◯ |
| | Ethanol | ◯ | x | ◯ |
| | n-butanol | ◯ | x | x |
| | Poly(vinyl alcohol) (polymeriza- | ◯ | ◯ | ◯ |
| | tion degree 500) 5 wt % solution | | | |
| | Poly(vinyl alcohol) (polymeriza- | ◯ | ◯ | ◯ |
| | tion degree 2000) 3 wt % solution | | | |
| Amines | Diethylamine | ◯ | x | x |
| | Triethylamine | ◯ | x | x |
| | n-butilamine | ◯ | x | x |
| | Tri-n-butilamine | ◯ | ◯ | x |
| | Poly(ethyleneimine) (average | ◯ | ◯ | x |
| | molecular weight 1000) 10 wt % | | | |
| | solution | | | |
| | Poly(ethyleneimine) (average | ◯ | ◯ | x |
| | molecular weight 10000) 10 wt % | | | |
| | solution | | | |
| Others | Acetone | ◯ | x | x |
| | Methylethyl ketone | ◯ | x | x |
| | Tetrahydrofuran | ◯ | x | x |

(1) Those ejected from the nozzle are marked by “◯”. Those not ejected or a little ejected are marked by “x”.
(2) Those developed 10 minutes after formation of the latent image are marked by “◯”. Those not developed are marked by “x”. Those not ejected from the nozzle are not evaluated since retention force cannot be examined.
(3) x is given if the odor of the water soluble material is felt by any one of the randomly selected ten persons. “◯” is given if odor is felt by no one.

diameter of 10 microns with an ejection volume of 1×10⁻⁹ cm³.

### (3) DEVELOPMENT

Ink is designed to be deposited on the portion of the plate where water soluble material is deposited. The following describes the characteristics of ink required to achieve this, and the system to deposit ink on the plate (development system).

### (3-1) Characteristics of Ink

The surface energy of ink used must be high enough to ensure that it is not deposited on the portion where the water soluble material of the plate is not deposited. For this reason, surfactant should not to be used for ink wherever possible. The required surface energy varies according to the ink repellency of the plate. So it cannot be determined generally, but ink having a lower surface energy can be used as ink repellency of the plate is higher.

When recovery of the plate is taken into account, ink must be removed from the plate by washing with water. Consequently, ink is required to be water-soluble. Furthermore, to ensure effective washing by water, the viscosity of ink is preferred to be lower. In this case, however, if viscosity is low, ink will be splashed to contaminate inside the system when the plate is driven at a high speed. Care must be taken to avoid this.

### (3-2) Development System

The system to adhere ink on the plate is designed to ensure that ink is deposited from the ink tank onto the portion of the plate where the water soluble material is deposited. To cope with the latent image of high resolution, it is important to control the volume of ink to be coated. In FIG. 2, ink is fed to the ink transfer roll 12 from the ink tank 10 through the ink transporting roll 11. A high resolution can also be achieved by controlling the volume of ink 9 to be fed by the ink transporting roll 11.

In order not to damage the latent image comprising the water soluble material, it is preferred to minimize the pressure of the ink coating roll in contact with the plate. In this connection, if ink has a low viscosity, the adequate amount of ink to the plate can be deposited by dipping the plate directly into the ink tank. An example of this is given in FIG. 1.

### (4) TRANSFER SYSTEM

Transfer is a step of ensuring that the ink image developed on the plate is transferred on paper. In this case, slippage between the plate and paper can be avoided by making sure that the peripheral speed of the plate is the same as the speed of the paper transporting roll, thereby preventing the image from being put into disorder. A drastic improvement of water resistance can be achieved by laminating resin on the transferred image surface, even when water based ink is used for the image.

To get a beautiful image, it is possible use the paper which allows ink to penetrate in the direction of thickness, in addition to controlling the transferred volume of ink. Furthermore, concurrent use of the mechanism to heat transfer roll and plate surface can also be mentioned as an effective way to ensure quick drying of ink. To put it more specifically, it is possible to consider a heater installed inside the plate or transfer roll, thereby heating the plate or transfer roll surface. In this case, if surface temperature is controlled not to exceed 80 degrees Celsius, excessive temperature does not occur on the surface, and ink and water soluble material are prevented from being dried. This allow ink to be effectively transferred on paper.

If ink surface tension is small, ink on the plate may be hard to transfer on paper. In this case, ink transfer is facilitated by exposing the developed plate to vapor. This can be considered to be because vapor is dissolved into ink to increase the surface tension of ink, with the result that deposition of ink on the plate is reduced.

### (5) PLATE RECOVERABLE SYSTEM

To form a new image on the plate upon completion of transfer, two methods are available; (1) replacement of the plate with a new one and (2) recovery of the plate according to the process described below. Ink is deposited on the plate after completion of printing a specified number of copies (a very small amount of water soluble material is considered to remain). Moreover, there is no more super-ink-repellency on the ink-deposited area. This means that recovery is a process having two functions; removal of ink and recovery of super-ink-repellency. This process consists of a step of water washing and a step of drying. The following describes the details:

### (5-1) Washing with Water

Water washing is a step of removing the remaining ink (and a slight amount of water soluble material) from the plate surface. Since ink is water-soluble, it can be washed away with water. The water outlet should be designed to ensure that water is not applied over the entire plate. A fine net is placed to cover the water outlet so that fine drops of water are applied to the plate. Or the outlet is used as a spray outlet to misty water is applied to the plate. These methods are effective. Incidentally, for the printer where the plate is recovered, a receiving pan must be provided to receive washing water produced in washing with water. A concurrent use of the receiving pan and suction fan improves the effect of preventing washing solution from entering the system. Almost all the waste water having producing in the washing step consists of water, and can be evaporated or reused by passing it through activated charcoal.

### (5-2) Drying

The plate having washed with water can be reused by drying. Drying is a step of removing water attached to the plate during water washing process. The plate is originally an super-ink-repellent surface. The super-ink-repellent surface contains fine irregularities, and is more difficult to dry than a flat plate. In this case, it is effective to blow hot air to the plate surface. Water drops are blown away by hot air and a very small amount of remaining water drop is evaporated, thereby ensuring quick drying. To ensure quick evaporation of water, hot water is preferred to have a temperature of 120 degrees Celsius or more. In this case, however, the maximum temperature of hot air must be kept below the heat resistant temperature of the super-ink-repellent surface. Furthermore, it is also possible to use a heat roll used in the toner fixing step of a laser printer and copier. In this case, the maximum temperature of hot air must also be kept below the heat resistant temperature of the super-ink-repellent surface.

What is more, almost all water can be removed by blowing high pressure air to the plate surface with an air compressor. Use of this method will reduce the time in the subsequent step of heating the plate by hot air, and will also save energy resulting from reduced hot air temperature.

If excessively heated in the drying step, a problem occurs that the ink deposited in the ensuing development step is dried up before transfer. To avoid this, the plate may have to be cooled before formation of the latent image. Use of a fan is effective in cooling since it ensures a uniform cooling of the entire plate surface. In this case, installation of a wind shield fence is preferred to keep down the effect of the hot air from the dryer. This will ensure effective drying of the plate by a dryer and cooling of the plate by a cooling fan.

Super-ink-repellency on the plate surface is recovered by going through said processes, and new image printing process can be started.

The image forming method and printer according to the present invention ensures that ink on the surface of the plate characterized by super-ink-repellency is deposited on a desired portion by depositing a water soluble material, with the result that a latent image is formed. In the ensuing development step, water based ink is deposited only on the portion where water soluble material is attached, and not on portion where water soluble material is not attached. Then developed image is transferred on the paper, thereby completing the entire printing step. When the identical image is to be created in multiple copies, said latent image formation step is omitted, and the development and transfer step is implemented. Plate recovery can be achieved by removal of ink by washing with water and drying of the plate by heat and wind. This facilitates formation of a plate and allows the plate to be recovered. Furthermore, this has made it possible to provide image formation method by using water based ink and printer. The following uses Embodiments to describe the present invention specifically, but the present invention is not restricted to such Embodiments.

### EMBODIMENT 1

The following describes the method of producing an super-ink-repellent coating medium used when the plate is formed: Epoxy resin (Epl004) (44 parts by weight) by Yuka Shell Epoxy Babushiki Kaisha, phenol resin (Maruka Lyncur M) (30 parts by weight) by Maruzen Petrochemical Co., Ltd. and catalyst (trade name: TEA-K) (1 part by weight) by Hokko Kagaku K. K. are dissolved into solvent consisting of a mixture between ethylmethyl ketone (950 parts by weight) and ethyleneglycol acetate mono-n-butyl ether (50 parts by weight). Then compound 1 (2 parts by weight) as fluorine-containing compound is added to it and is agitated sufficiently. Then Aerosil 130 (average grain size: about 16 nm) (8 parts by weight) by Nihon Aerosil Co., Ltd. and NipsilE-220A (average grain size: about 1.5 microns) (8 parts by weight) by Nippon Silica Industries Co., Ltd. are added and agitated sufficiently, thereby getting the super-ink-repellent coating medium.

The following describes how to manufacture the plate: A 1 mm-thick aluminum board 1 (20×20 mm) having an L-shaped grip (one side: 5 mm) in FIG. 1 is dipped in said super-ink-repellent coating medium for ten seconds. Then the board is pulled up at a speed of 3 cm/sec. This board is heated at a temperature of 120 degrees Celsius for 30 minutes, then at 180 degrees Celsius for 45 minutes. After the board is cooled down to the normal temperature, the portion of the board where the super-ink-repellent coating medium adhere exhibits super-ink-repellency. Thus, a plate is produced from a board as substrate.

A latent image is formed on this plate by discharging ethyleneglycol as a water soluble material 2 from the head for latent image formation 3 onto this plate, as shown in (A) of FIG. 1. Ethyleneglycol is infinitely diluted in water. An ejecting head 3 has an inner diameter of 10 microns with an ejection volume of 1×10⁻⁹ cm³. In this way, it is possible to manufacture a printing plate for the printer using water based ink. Incidentally, the diameter of the minimum dot in the latent image is 12 microns.

To check if this plate can function as a printing plate or not, authors of the present invention tried to carry out development and transfer on paper. The plate was dipped into water based ink in the pad 4 shown in FIG. 1. Ink was deposited only onto the portion where water soluble material 2 was attached, with the result that latent image was developed by ink. Then the developed image was brought in contact with paper 5. This resulted in ink on the plate being transferred onto paper 5. Incidentally, the minimum dot of the transferred image was 10 microns.

This above experiment has made it clear that the printing plate in this Embodiment functions as a printing plate of the printer where an image is formed by using water based ink. When the identical image was created in multiple copies, the latent image formation step was omitted for the second copy and thereafter, and an image could be formed merely by development and transfer.

Then after transfer, distilled water was sprayed onto the surface of the plate by the cleaner 6, thereby ensuring the remaining ink to be washed away, as shown in (D) of FIG. 1. After that, hot air was applied for 30 seconds by a dryer 7 (power consumption: 1000 W) to dry the plate, as shown in (E). After drying, the plate again exhibited super-ink-repellency. Using this plate, (A) to (C) steps of FIG. 1 were performed again. As a result, the same image as the above could be obtained.

The above description has made it clear that the printing plate according the present Embodiment can be recovered by washing and drying. That the plate can be recovered means that the plate can be used repeatedly. It has the effect of cutting down the cost of the plate in the printing.

### Reference Example 1

Using the same aluminum-made board as that in Embodiment 1 except that the super-ink-repellent coating medium is not coated, authors of the present invention tried to form an image and to recover the plate, as shown in (A) to (E) of FIG. 1. However, in order to develop a latent image after formation thereof, the authors dipped the plate in the pad containing water based ink, and found out that ink was deposited on almost the entire surface. Namely, development in conformance to the latent image could not achieved. Thus, the desired image could not be formed by transferring this image. This has revealed that formation of an image by the printing plate according to the present invention requires the plate to have super-ink-repellency.

### Reference Example 2

Using the same aluminum-made board as that in Embodiment 1 except that rape-seed oil instead of ethyleneglycol was used as a water soluble material, authors of the present invention tried to form an image and to recover the plate, as shown in (A) to (E) of FIG. 1. Incidentally, after rape-seed oil and water are mixed in the same amounts and are agitated, they are left to stand; then they are separated in two layers. Namely, rape-seed oil hardly dissolves in water, not to mention infinite dilution. This shows that rape-seed oil does not pertain to the water soluble material according to the present Specification. After formation of a latent image, development and transfer, the plate was washed with water, and was then dried, similarly to the case of Embodiment 1. The latent image of rape-seed oil remained on the surface of the plate. The portion where the rape-seed oil of the plate was attached did not exhibited super-ink-repellency. So formation of a latent image, development and transfer were tried again using this plate. Part of the previous image was formed overlapped on that image.

This has revealed that formation of an image by the printing plate according to the present invention requires a water soluble material to be used when latent image is to be formed.

### EMBODIMENT 2

The following describes the Embodiment of a printer where a printing plate mechanism is built in. First, it describes how to manufacture the plate to be used: An aluminum-made sleeve having an outer diameter of 20 cm and a length of 22 cm is dipped in the super-ink-repellent coating medium prepared in Embodiment 1, and is pulled up at a speed of 3 cm/sec. This aluminum sleeve is heated at a temperature of 120 degrees Celsius for 30 minutes, then at 180 degrees Celsius for 45 minutes. After the aluminum sleeve is cooled down to the normal temperature, the portion of the aluminum sleeve where super-ink-repellent coating medium is deposited exhibits super-ink-repellency. Thus, a plate is produced from an aluminum sleeve as substrate.

After this plate is mounted on a device shown in FIG. 2, the device is operated as a printer. First, a latent image is formed on the plate 8. It is developed and is finally transferred. This operation process will be described below.

Latent image forming step: Ethyleneglycol as one type of water soluble material is ejected from the head for latent image formation 3 toward the portion of the plate where ink is to be deposited. The water soluble material ejecting head has an inner diameter of 10 microns with the ejection volume of 1×10⁻⁹ cm³. The minimum dot of the latent image formed on the plate a diameter of 12 microns.

Development step: After formation of the latent image plate 8 is brought in contact with ink 9. Ink 9 is deposited only on the area where water soluble material is attached. Ink 9 is located in an ink tank 10, and is fed to an ink transfer roll 12 by an ink transporting roll 11. Then ink is coated on the plate 8 from the ink transfer roll 12. The surface of the ink transfer roll 12 is wound with a fine-meshed sponge.

Transfer step: In this step, ink 9 is transferred onto paper 13 from the plate coated with ink. Paper 13 is fed between transfer roll 16 and plate 8 through paper transporting rolls 14 and 15. The distance between paper 13 and plate 8 adjusted to a proper value by the paper transfer rolls 14 and 15. After transfer, paper 13 is removed from the plate 8 by means of paper transporting roll 15.

Through the steps described above, the printer according to this Embodiment could form an image using water based ink. The diameter of the minimum dot in the transferred image was 10 microns. When the identical image was created in multiple copies, the latent image formation step was omitted, and only the development and transfer step were implemented successfully.

The following describes the recovery of the plate 8 in the printer in the present Embodiment. This process consists of a water washing step and a drying step.

Water washing step: This is a step of removing ink from the surface of the plate. Ink 9 is water-soluble. Cleaner 17 blows water toward plate 8 to remove ink 9 from the surface of the plate 8. Waste water produced by washing is trapped by a waste water receiver 18. Drying is a step of removing water remaining on the surface of plate 8.

Drying step: This is a step of drying the plate 8 wet by washing with water, thereby ensuring recovery thereof. This step uses hot air coming from the dryer 19. This step recovers super-ink-repellency on the surface of the plate 8, and allows a step of printing new images to be started. Frequent recovery of the plate 8 will heat the plate, so the plate is cooled by a cooling fan 20. Furthermore, a wind shield fence 21 is installed to separate between the hot air from the dryer 19 and cold air from the cooling fan 20.

Upon completion of the above steps, the entire process of recovering the plate in the printer according to the present Embodiment is now complete. Using the recovered plate 8, authors of the present invention again performed formation of a latent image, development and transfer, and succeeded in printing a required image on paper.

This experiment has verified that the device according to the present Embodiment is a printer equipped with recovery function. Recovery of a plate signifies the capability of repeated use of the plate and hence a reduced cost of the plate in printing.

### Reference Example 3

On the device illustrated in FIG. 2, authors of the present invention mounted mounted the same aluminum-made sleeve as that in Embodiment 2 except that the super-ink-repellent coating medium is not coated, and then tried to form an image and to recover the plate. After formation of a latent image, water based ink was brought in contact for development. The result was that ink was deposited on almost the entire surface. Namely, development according to the latent image failed; therefore, a desired image could not be obtained when this was transferred to paper. This shows that the image forming surface is required to have super-ink-repellency in order to form an image with the printer according to the present invention.

### Reference Example 4

Using the same device as that in Embodiment 2 except that rape-seed oil instead of ethyleneglycol was used as a water soluble material, authors of the present invention tried to form an image and to recover the plate. As described in the explanation of Reference Example 2, rape-seed oil does not pertain to the water soluble material according to the present Specification.

The surface of the plate was examined after completing one cycle of the steps of latent image formation, development, transfer, washing and drying, and the latent image of remaining rape-seed oil was observed on the surface. The portion of the plate where rape-seed oil was attached did not show super-ink-repellency. A new cycle of latent image formation, development and transfer steps was carried out using this plate. Part of the previous image was formed overlapped on the image.

This verifies that formation of an image by the printer according to the present invention requires use of a water soluble substance when the latent image is formed.

### Embodiment 3

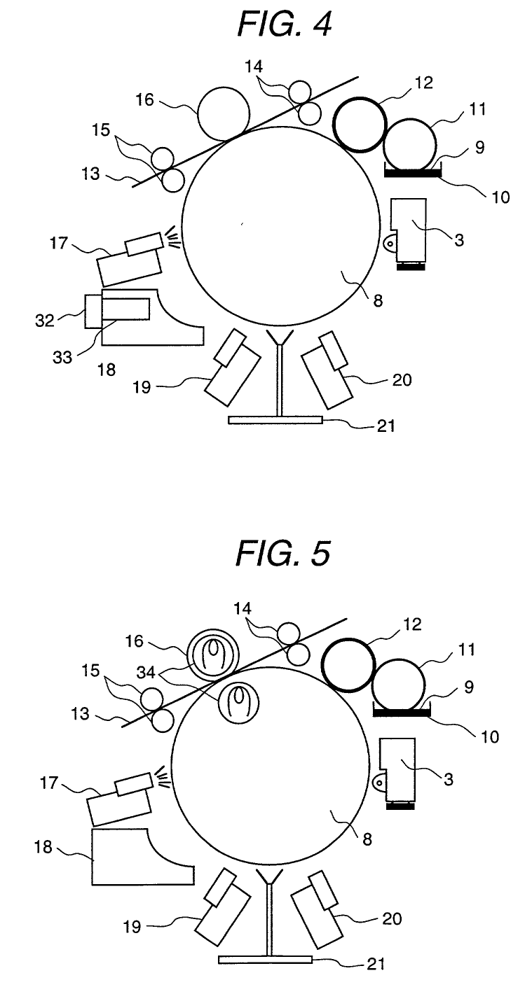

When repeated recovery of the plate by the device discussed in Embodiment 2 was carried out, a very small portion of waste water (about 1 percent of the entire waste water) splashes around the waste water receiver to contaminate inside the system. The remaining 99 percent entered the waste water receiver. So the device mentioned in Embodiment 2 was improved to manufacture a printer provided with a suction fan 32 to suck cleaning solution into the waste water receiver 18 and a suction nozzle 33, as shown in FIG. 4.

Almost all waste water (about 99.9 percent of the entire waste water) can be trapped into the waste water receiver by operating this system. This has demonstrates the effect of avoiding contamination caused by contaminants due to waste water inside the system. This system ensures the same printing as that of Embodiment 2 as well as recovery of the plate.

### EMBODIMENT 4

Water based ink is used in the system according to the present invention. To promote quick drying of ink on paper, an incandescent lamp 34 (100W) is in the vicinity of the transfer area inside the transfer roll and inside the plate, as shown in FIG. 5. The transfer roll and plate were heated by heat generation of this incandescent lamp, and ink on paper dried up quicKry during the transfer process.

Immediately after printing, the image was touched by hand, but ink was not applied to hand. This shows that handling of the printed matter immediately after printing is much facilitated by adding a heating mechanism to the transfer mechanism. This system ensures the same printing as that of Embodiment 2 as well as recovery of the plate.

### EMBODIMENT 5

The same operations as in Embodiment 2 were performed except that ethyleneglycol was replaced by ethyleneglycol monomethylether as water soluble material. It has been made clear as a result that this system ensures the same printing as that of Embodiment 2 as well as recovery of the plate. It should be noted that ethyleneglycol monomethylether is infinitely diluted in water.

### EMBODIMENT 6

The same operations as in Embodiment 2 were performed except that ethyleneglycol was replaced by diethyleneglycol as water soluble material. It has been made clear as a result that this system ensures the same printing as that of Embodiment 2 as well as recovery of the plate. It should be noted that ethyleneglycol is infinitely diluted in water.

### EMBODIMENT 7

The same operations as in Embodiment 2 were performed except that ethyleneglycol was replaced by tetraethyleneglycol as water soluble material. It has been made clear as a result that this system ensures the same printing as that of Embodiment 2 as well as recovery of the plate. It should be noted that tetraethyleneglycol is infinitely diluted in water.

### EMBODIMENT 8

The same operations as in Embodiment 2 were performed except that ethyleneglycol was replaced by 5% poly(vinyl alcohol) (by Wako Junyaku Co., Ltd. with degree of polymerization about 500) aqueous solution as water soluble material. It has been made clear as a result that this system ensures the same printing as that of Embodiment 2 as well as recovery of the plate. It should be noted that 5% polyvinyl alcohol aqueous solution is infinitely diluted in water.

### EMBODIMENT 9

Instead of an aluminum-made sleeve with a coating film of super-ink-repellent coating medium as a plate, a plate having tetrafluoroethylene-ethylene copolymer (hereinafter referred to as “ETFE” for short) on the surface was manufactured. It was mounted on the same system as that in Embodiment 2, and the same operations as in Embodiment 2 were performed. It has been made clear as a result that this system ensures the same printing as that of Embodiment 2 as well as recovery of the plate. The following describes how to manufacture the plate according to the present Embodiment:

First, a 0.5 mm thick ETFE sheet is pressed against the outside of the 3 mm thick stainless steel sleeve having an inner diameter of 20 cm. Its surface is roughened using a belt sander (M648) by Kikugawa Iron Works. In this experiment, a #240 belt was used. Then this sleeve is cleaned by an ultrasonic cleaner, and chips produced by roughening is removed. Cleaning solvent used in this experiment was PF-5080 by 3M Co., Ltd. In this way, a plate having ETFE on the surface was manufactured.

### EMBODIMENT 10

Instead of an aluminum-made sleeve with a coating film of super-ink-repellent coating medium as a plate, a plate having tetrafluoroethylene-hexafluoropropylene copolymer (hereinafter referred to as “FEP” for short) on the surface was manufactured. It was mounted on the same system as that in Embodiment 2, and the same operations as in Embodiment 2 were performed. It has been made clear as a result that this system ensures the same printing as that of Embodiment 2 as well as recovery of the plate. The plate manufacture method is the same as that in Embodiment 9, except that FEP is used instead of ETFE.

The above description uses paper as an object to be printed. The objected to be printed is not limited to paper; it is possible to print on a great variety of objects including glass, plastic, metal, wood and cloth. It is also possible to provide coating in advance in conformance to ink to be used on the surface of the object to be printed.

The present invention facilities formation of a plate and provides a printing system capable of regenerating the plate, and press plate.

What is claimed:

1. A printing plate used in a printer to form an image using water based ink characterized in that,
prior to formation of a latent image, the surface forming the latent image exhibits super-ink-repellency to the ink to be used;
said printing plate allows a water soluble material forming the latent image to be deposited thereon;
the latent image can be formed by allowing said water soluble material deposited on said printing plate surface; and
said printing plate can be recovered as an plate which allows a new latent image to be formed by washing said printing plate with water and drying it, upon completion of ensuing processes of development and transfer.

2. A printer comprising at least;
(1) a plate,
(2) a mechanism forming a latent image on said plate,
(3) a mechanism allowing ink to be deposited and developed on said plate where the latent image is formed, and
(4) a mechanism to transfer said developed image onto paper;
and said ink is water based ink;
said printer further characterized in that
prior to formation of a latent image, the surface of the plate exhibits super-ink-repellency to the ink to be used;
said printing plate allows a water soluble material forming the latent image to be deposited thereon;
the latent image can be formed by allowing said water soluble material deposited on said printing plate surface on said plate surface; and
a mechanism is provided to permit said printing plate to be recovered as an plate which allows a new latent image to be formed upon completion of ensuing processes of development and transfer;
said mechanism contains at least a device to remove ink deposited on said plate and a device to dry said plate.

3. A printer according to claim 2 characterized in that a mechanism to heat said plate or transfer mechanism is added inside said plate and transfer mechanism.

4. A printer according to claim 2 characterized in that a mechanism to suck waste water generated in said washing step is added.
